(19) United States
(12) Patent Application Publication
(10) Pub. No.: US 2018/0068383 A1
(43) Pub. Date: Mar. 8, 2018

(54) BANK SYSTEM, METHOD AND PROGRAM FOR CORPORATE FINANCE OVERSEAS CREDIT MANAGEMENT

(71) Applicant: SUMITOMO MITSUI BANKING CORPORATION, Tokyo (JP)

(72) Inventors: Kiyonori UGAJIN, Tokyo (JP); Kazuya IKEDA, Tokyo (JP); Fumitaka KATO, Tokyo (JP); Yoshiaki YODA, Tokyo (JP); Masato HAYASHI, Tokyo (JP); Takuya MIZUGUCHI, Tokyo (JP); Sho MATSUO, Tokyo (JP); Masato KANO, Tokyo (JP)

(21) Appl. No.: 15/563,311

(22) PCT Filed: Mar. 31, 2015
(86) PCT No.: PCT/JP2015/001875

§ 371 Date: Sep. 29, 2017

(51) Int. Cl. G06Q 40/02; G06Q 20/02; G06Q 20/06

(52) U.S. Cl. CPC G06Q 40/02; G06Q 20/06; G06Q 20/023

(57) ABSTRACT

A bank system for corporate finance overseas credit management includes: first storage storing customer information sharable by a plurality of entities; second storage storing information relating to a credit transaction management unit (Deal), approval means for approving execution of a credit transaction described in a credit application, the approval means having customer information and Deal information at the time of creation of the credit application and generating a first signal at the time of approval of the credit application; and control card generating means for generating a control card in response to the first signal, the control card indicating progress status of ancillary processes of the approved credit transaction. The Deal information has information of lending office(s) and information of borrower(s), the borrower(s) being associated with the customer information. The customer information and the Deal information are maintained by a first entity.

### TECHNICAL FIELD

The present invention relates to a bank system, a method, and a program for corporate finance overseas credit management. More specifically, the present invention relates to a bank system, a method, and a program for corporate finance overseas credit management having customer information sharable by a plurality of entities, having information relating to a management unit of credit transactions in which one or more lending offices and one or more borrowers can be handled, and capable of grasping progress status of ancillary processes of credit transactions.

### BACKGROUND ART

In recent years, as the scale of overseas business expands, there are increasing amount of overseas credit exposure in banks, number of borrowers, and number of countries and regions where borrowers are located. Many companies establish subsidiaries or branches, and/or build plants, in a plurality of countries and regions in order to expand business opportunities. Under such a situation, globally operating major banks, when dealing with such companies, usually finance the companies via overseas branches of the banks or subsidiaries relating to the banks. For example, a company may ask a branch of the bank in a European country A to finance construction of a plant in the country A. Another company, whose head quarter is located in a Southeast Asian country B, may ask a branch of the bank in the country B to finance construction of a plant in a Southeast Asian country C and receive funds from a branch of the bank in the country C. In such cases, usually, credit ancillary processes are not completed solely by the branch or subsidiary located in the country where the application for financing has been made, but branches and head offices located in a plurality of countries share information and perform credit ancillary processes. Although the head office of a bank is generally located in the home country of the bank, it may also be established in another country or region. For example, some of the major banks divide the world into a plurality of regions, establish head offices (for example, European head office, Asia-Oceanian head office, U.S. head office, and the like) in respective regions, and manage branches or subsidiaries in countries within the regions.

As already described, there are increasing number of cases where branches, subsidiaries, and head offices located in a plurality of countries and regions are involved in a credit business related to corporate finance. On the other hand, a bank may often handle structured finance besides corporate finance. Structured finance is finance based on a particular business asset and cash flow brought about by the business, rather than the credit worthiness of the company and may include, for example, financing a special purpose company (SPC) established by related parties. An SPC, being a shell company invested and established by a plurality of companies involved in a certain project (for example, oilfield development), turns out to be the borrower of the finance. Although the plurality of companies involved in the project are involved in the project as related parties, they are not borrower. In globally operating banks, there are increasing number of cases of such structured finance.

Banks have been developing various bank systems over many years. For customer companies whose operating regions are only domestic, banks have already created systems for customer information management, decision systems for making credit decisions, and systems for credit management, the systems having been operated as domestic bank systems. As already described, with global expansion of operations of companies, bank systems are required to meet the needs of globally operating companies. Under a situation with an increasing number of cases of corporate finance and structured finance for companies globally expanding businesses, and with an increasing number of overseas head offices, branches, and subsidiaries, it has been necessary for banks to construct a new system which is capable of handling a corporate finance and/or a structured finance and which allows a plurality of offices in a bank to be involved therein.

Patent Literature 1 discloses a system which merely makes funding decisions between a plurality of countries, and Patent Literature 2 discloses a system for applying for a structured finance. Accordingly, with regard to conventional bank systems, there are only known systems focusing on particular ones of overseas affairs, and there has been no system for performing customer information management, deal management, credit decisions for overseas credit.

In a conventional bank system, when the performance of a certain company has suddenly decreased, it takes considerable time to extract financing deals associated with the company. When a global financial crisis (for example, Lehman' s fall) has occurred, or when a certain project has resulted in an enormous loss, it takes considerable time for a conventional bank system to extract companies affected by such an event. When a certain event (for example, fall of crude-oil price) has occurred, it is difficult for a conventional bank system to extract companies whose performance decreases due to the event.

### CITATION LIST

### Patent Literature

PTL 1: Japanese Patent Laid-Open No. 2005-276012

PTL 2: Japanese Patent Laid-Open No. 2002-352087

### SUMMARY OF INVENTION

It is an object of the present invention to provide a bank system for overseas credit management of corporate finance allowing a plurality of offices in a bank to be involved therein, the bank system being capable of providing progress status of credit ancillary processes, and capable of extracting financing deals associated with a particular customer.

A bank system for corporate finance overseas credit management as an aspect of the present invention includes: first storage means for storing customer information, the customer information being sharable by a plurality of entities; second storage means for storing information relating to a credit transaction management unit, the information relating to a credit transaction management unit having information of one or more lending offices and information of one or more borrowers, the borrowers being associated with the customer information; approval means for approving execution of a credit transaction described in a credit application, the approval means having the customer information and the information relating to a credit transaction management unit at the time of creation of the credit application, and generating a first signal at the time of approval of the credit application; and control card generating means for generating a control card in response to the first signal, the control card indicating progress status of ancillary processes of the approved credit transaction. The customer information and the information relating to a credit transaction management unit are maintained by a first entity.

A method performed in a bank system for corporate finance overseas credit management as another aspect of the present invention includes the steps of: updating customer information, the customer information being sharable by a plurality of entities; updating information relating to a credit transaction management unit, the information relating to a credit transaction management unit having information of one or more lending offices and information of one or more borrowers, and the borrowers being associated with the customer information; acquiring, in response to creation of a credit application, the customer information and the information relating to a credit transaction management unit; generating a first signal in response to approval of a credit transaction described in the credit application; and generating a control card in response to the first signal, the control card indicating progress status of ancillary processes of the approved credit transaction. The customer information and the information relating to a credit transaction management unit are maintained by a first entity.

According to the present invention, the bank system is capable of extracting financing deals associated with a company exhibiting a poor performance by searching Deal information or SL information on the basis of the customer ID of the company. According to the present invention, when a certain project has resulted in an enormous loss, the bank system is capable of identifying parties involved on the basis of the SL information, and extracting financing deals for each of the identified parties involved. According to the present invention, the bank system is capable of providing progress status of credit ancillary processes.

### BRIEF DESCRIPTION OF THE DRAWINGS

Detailed understanding of embodiments disclosed in the present Description can be acquired from the following explanation illustrated in relation to the accompanying drawings.

FIG. 1 is a drawing illustrating a bank system and a plurality of bank terminals and a network communicably connecting the bank system and the plurality of bank terminals;

FIG. 2 is an explanatory diagram of a system configuration of the bank system;

FIG. 3 is a functional block diagram of a customer information management subsystem;

FIG. 4 is a functional block diagram of a deal information management subsystem;

FIG. 5 is a functional block diagram of a user management subsystem;

FIG. 6 is a functional block diagram of a decision subsystem;

FIG. 7 is a functional block diagram of a credit management subsystem;

FIG. 8A is a drawing illustrating a flow of credit ancillary processes in a first case;

FIG. 8B is a flow diagram describing in detail a flow of operation in the first case;

FIG. 9A is a drawing illustrating a flow of credit ancillary processes in a second case;

FIG. 9B is a flow diagram describing in detail a flow of operation in the second case;

FIG. 10A is a drawing illustrating a flow of credit ancillary processes in a third case;

FIG. 10B is a flow diagram describing in detail a flow of operation in the third case;

FIG. 11 illustrates an example of a structured finance;

FIG. 12 describes an example of a process flow of an access control performed in a bank system;

FIG. 13 illustrates an exemplary format of a credit application;

FIG. 14 illustrates a registration screen of an exemplary risk factor; and

FIG. 15 illustrates an example of a control card.

### DESCRIPTION OF EMBODIMENTS

<Definitions of Terms>

Meaning of the following terms used in the present Description will be defined.

Overseas credit: Financing provided by an overseas branch of a bank or a subsidiary relating to the bank to a customer of the bank. There are “facility” and “Exposure” as terms corresponding to credit. The former is used when referring to individual credit, and the latter is used when referring to the entire credit for a customer.

Overseas credit management: Management of the credit status of a finance destination company in terms of overseas credit.

Lending Office: A branch or subsidiary taking responsibility of credit. In a case where a plurality of branches or subsidiaries deal with a single customer, a Primary Lending Office (PLO) refers to an office which collectively manages customer information and performs borrower evaluation, and a Secondary Lending Office (SLO) refers to an office other than the Primary lending office.

Global company: A company which is expanding business in many regions and needs to be managed by a plurality of lending offices.

SL (Specialized Lending): Approximately synonymous with structured finance (SF). In the present Description, SL and SF may be used interchangeably.

In the present Description, a credit management scheme performed in a Bank 1 and a system for performing the scheme will be described. The Bank 1 may have branches and subsidiaries associated with the Bank 1 in a plurality of countries and regions. The Bank 1 may divide the world into a plurality of regions, establish head offices (for example, European head offices, Asia-Oceanian head offices, U.S. head offices, and the like) in respective regions, and manage branches or subsidiaries in countries within the regions. Head offices, branches and subsidiaries may be referred to as “entities”.

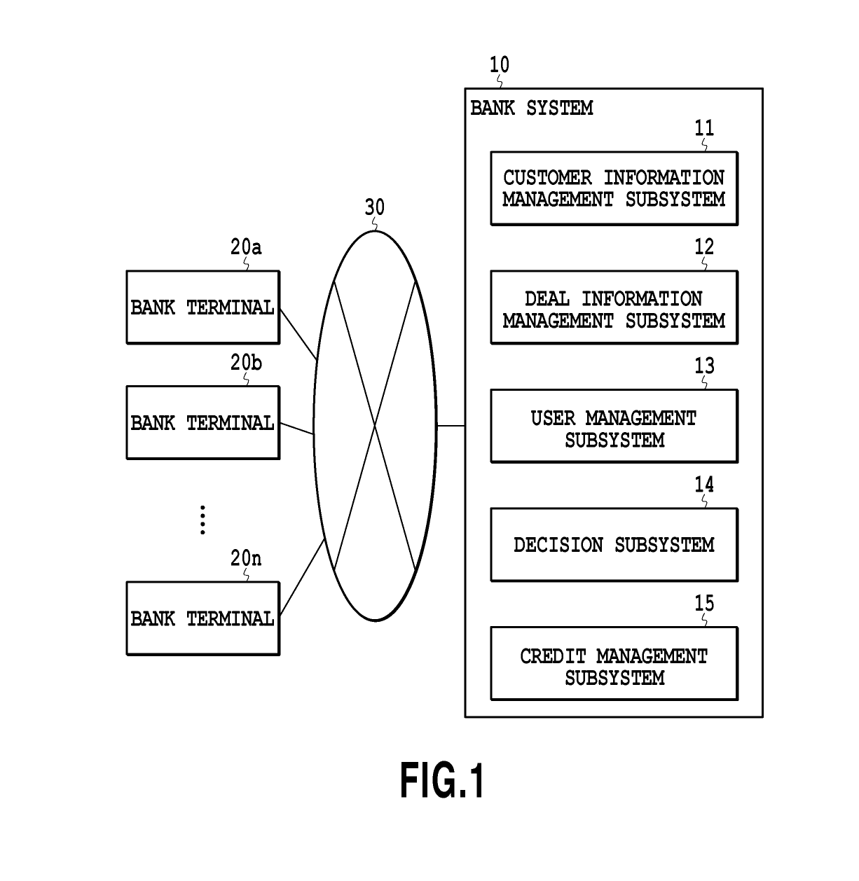

FIG. 1 is a drawing illustrating a bank system 10, a plurality of bank terminals 20, and an intra-bank network or the Internet 30 (referred to as a “network 30” in the present Description) communicably connecting the bank system 10 and the plurality of bank terminals 20a, 20b, . . . 20n (collectively referred to as “bank terminal 20” in the present Description), which may be used by the Bank 1. The bank system 10 is a system capable of handling deposit business, lending business, domestic exchange business, foreign exchange business, and the like. For explanatory purposes, in the present Description, there will be described, among the major functions of the bank system 10, functions and processes related to credit management for a company expanding business in one or more countries and regions.

The bank terminal 20 is a terminal capable of accessing the bank system 10 via the network 30 to use a function provided by the bank system 10. The bank terminal 20 may be a terminal that a bank clerk can use, and is not limited in particular. For example, the bank terminal 20 may include a personal computer (PC), a laptop, a tablet terminal, or any other type of devices operable in a wired or wireless environment. The network 30 may be a known network which allows mutual communication, including the Internet, a dedicated line, or the like, and is not limited in particular.

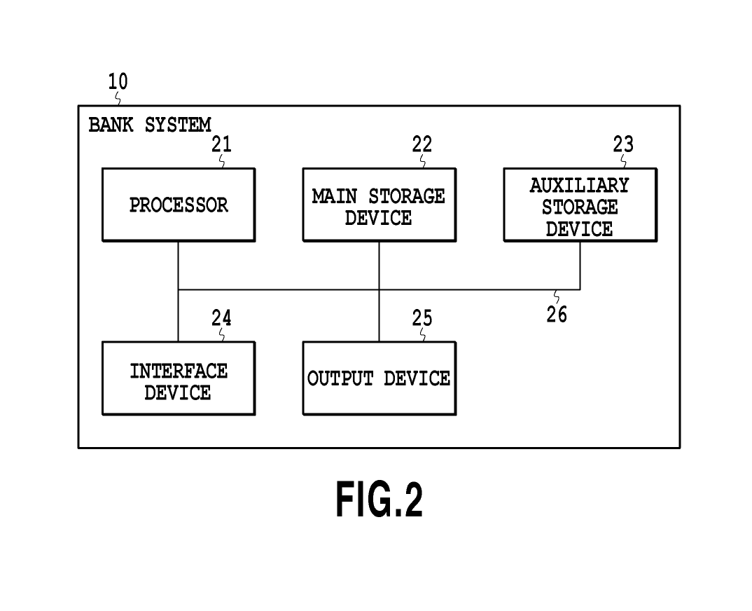

FIG. 2 is an explanatory diagram of a system configuration of the bank system 10. The bank system 10 may include a processor 21, a main storage device 22, an auxiliary storage device 23, an interface device 24, and an output device 25. The devices 21 to 25 may be connected to each other by a bus 26 or the like.

The processor 21, which performs control of respective components and arithmetic processing of data in the bank system 10, is capable of reading various programs stored in the auxiliary storage device 23 to the main storage device 22 and executing them. The main storage device 22 is capable of storing various transmission and reception data, computer-executable instructions, and data subjected to arithmetic processing by the instructions. The auxiliary storage device 23 is a storage device, such as an HDD (Hard Disk Drive) or an SSD (Solid State Drive), and is capable of storing data or programs for a long time.

FIG. 2 illustrates an embodiment in which the processor 21, the main storage device 22, and the auxiliary storage device 23 are provided in a same computer. In another embodiment of the present invention, the bank system 10 may also be configured to realize distributed parallel processing by a plurality of computers, using the plurality of processors 21, the main storage device 22, and the auxiliary storage device 23. In another embodiment of the present invention, there may also be employed an embodiment in which a plurality of computers are provided for the bank system. 10, the plurality of computers sharing a single auxiliary storage device 23.

The interface device 24 serves as an interface when transmitting and receiving data to and from other systems and devices. The interface device 24 is capable of providing an interface for receiving various commands or input data (e.g., data of various master files) from a system operator. The output device 25 is capable of displaying data processed by the processor 21 and/or data read out from various databases or files. The output device 25 is capable of providing a function for printing data displayed on the display.

As illustrated in FIG. 1, the bank system 10 may include a customer information management subsystem 11, a deal information management subsystem 12, a user management subsystem 13, a decision subsystem 14, and a credit management subsystem 15.

The subsystems 11 to 15 may each include a processor, a main storage device, an auxiliary storage device, an interface device, and an output device which may be connected to each other via a bus or the like, and the devices may have functions similar to the devices 21 to 25.

The customer information management subsystem 11 is used for managing customer information used in a credit management process. The customer information used in the present invention can be used not by individual lending offices but across a plurality of departments and lending offices in a bank, and thus is different from customer information in a conventional CIF (customer information file). The customer information in CIF has been created and maintained by respective lending offices. In a case where a particular company is trading with a plurality of lending offices in a bank, each of the lending offices has been creating and maintaining customer information and accordingly there has not been performed a centralized information management in the Bank 1. In the present Description, customer information will be referred to as a “corporate card” in order to be distinguished from the conventional CIF.

The deal information management subsystem 12 is used for managing deal information (Deal) relating to financing. The deal information management subsystem 12 is capable of handling Deal of both corporate finance and structured finance. Deal may include fact information such as background and reason of funding needs of a customer company, as well as usage of the funds and loan period.

The user management subsystem 13 is capable of providing a system function accessible by a logged-in user, an access control function which controls data, and a check function which monitors user log. The access control function allows only a particular user to access a particular system function or data. The check function is capable of collecting and storing logs of particular ones of user operations performed in the bank system 10. Particular operations whose logs to be collected may be preliminarily determined.

The decision subsystem 14 is a system for creating a credit application with regard to overseas credit, circulating it around related departments, and acquiring approval from a decision-making authority. The decision subsystem 14 is capable of preserving a corporate card and Deal at the time point of examining the content of the credit application. The corporate card and Deal may be preserved at the time point of starting creation of the credit application and/or the time point of decision. The decision subsystem 14 may create and store, when a credit application is circulated from a certain entity to another entity, a copy of the credit application.

The credit management subsystem 15 is capable of supporting credit business management and enhancing cooperation between related departments and lending offices, as well as internal management. The credit management subsystem 15 is capable of providing a function of checking whether or not affairs before execution of financing and affairs after execution of financing are appropriately performed.

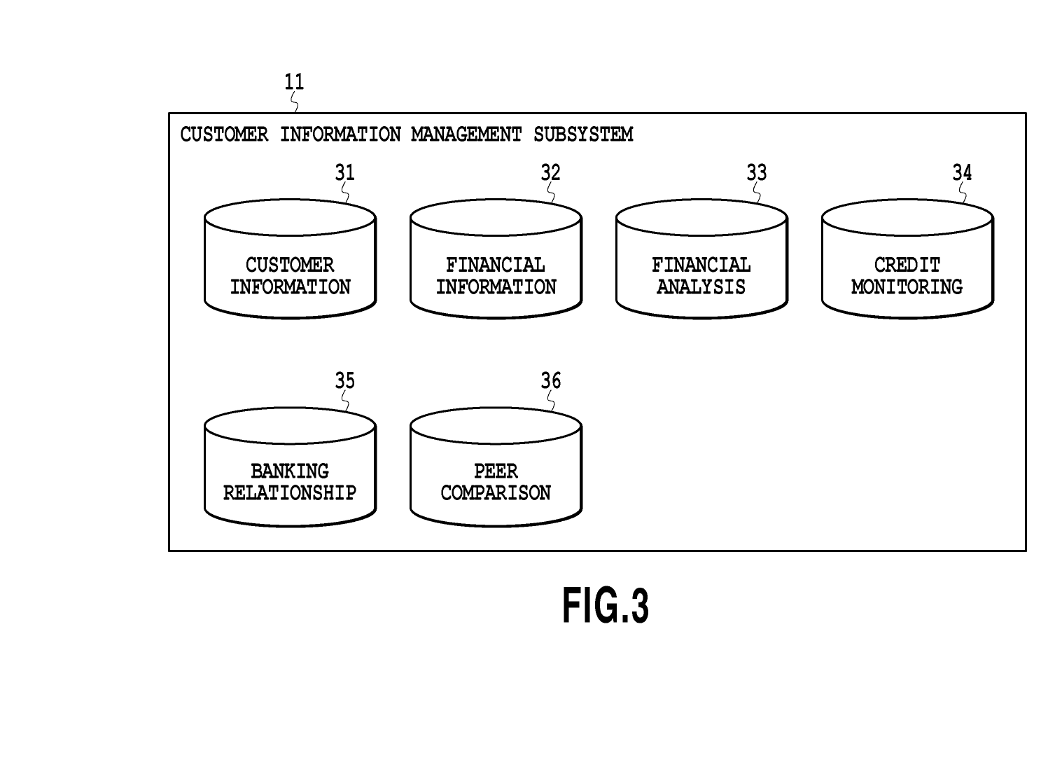

FIG. 3 is a functional block diagram of the customer information management subsystem 11. The customer information management subsystem 11 may include customer information 31, financial information 32, financial analysis 33, credit monitoring 34, banking relationship 35, and peer comparison 36. The elements 31 to 36 are data shared in the bank system 10, and may also be collectively referred to as a “corporate card”. Since the corporate card may be shared by a plurality of departments and lending offices, it is customer information different from the conventional CIF.

The customer information 31, which is a customer profile, may include attribute information, such as customer ID, company name, location of head quarter, year established, number of employees, location of plant and/or branch (names of country and city), stock information, shareholders, group structure, management history, relation to the Bank 1, key-person, business classification, region-wise segment, main customer, and main supplier.

The financial information 32 may include profit and loss statements, balance sheets, cash flow statements of customers and the original data of the financial information. The financial information 32 may include data across a plurality of calendar years. The financial information 32 may include actual and predicted data.

The financial analysis 33 may include an analysis result based on information stored in the financial information 32. Financial analysis is performed by a staff of the Bank 1, and the analysis result may be used for credit decision.

The credit monitoring 34 may include monitoring information, such as credit rating of borrower, status of borrower (excellent, caution, etc.), grade of borrower (high, medium, low, etc.). The content of the monitoring information may be determined on the basis of a criterion defined by the Bank 1, and/or may be information acquired from a rating company.

The banking relationship 35 may include information, such as all financial institutions from which a borrower is borrowing money, and amount of money borrowed from each financial institution. The peer comparison 36 may store information (for example, financial information) of a competing company of a borrower. Selection of a competing company is determined on the basis of information of another borrower in the same field of business, or by the staff of the Bank 1.

Access control to information stored in the elements 31 to 36 is performed by the user management subsystem 13. The access control is performed, after the information to be referred to has been specified, in accordance with the organization the access user belongs to, information of credit job position and role, compliance information of the country and region in which the entity managing customer data is located, and information as to whether or not the customer has agreed that another entity refers to the customer data. The customer information management subsystem 11 may have information as to whether or not the customer has agreed that the information stored in the elements 31 to 36 is shared. An entity may indicate respective departments of head office of the Bank 1, branches, and subsidiaries associated with the Bank 1.

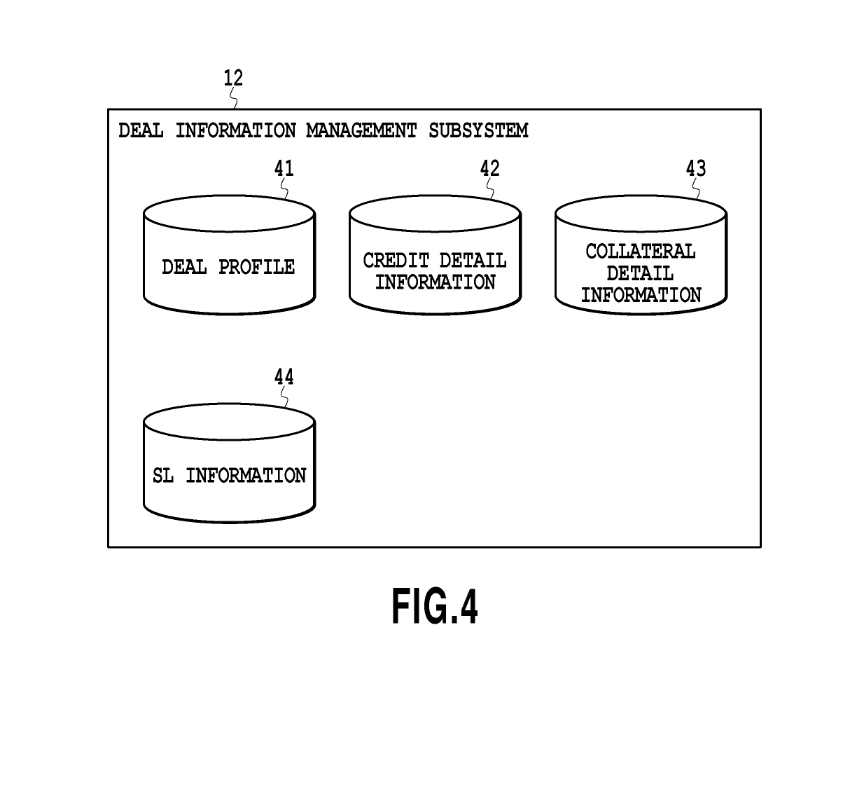

FIG. 4 is a functional block diagram of the deal information management subsystem 12. The deal information management subsystem 12 is capable of handling information for a credit transaction management unit (Deal). The deal information management subsystem 12 may include Deal Profile 41, credit detail information 42, collateral detail information 43, and SL information 44. Elements 41 to 44 may be collectively referred to as “Deal information”. The deal information management subsystem 12, unlike the conventional bank system, is capable of handling transactions in which a plurality of lending offices are involved and/or transactions in which a plurality of borrowers are involved.

The Deal Profile 41 is capable of storing a profile of deal information. The information stored in the Deal Profile 41 may be associated with information to be stored in the credit detail information 42 and the collateral detail information 43 using an identifier (Deal number) of the deal information.

The Deal Profile 41 may include basic information 411 (Deal number, Deal name, Deal owner, one or more lending offices, one or more borrowers), a Deal summary 412, a Deal background 413, a lending structure 414, and support sharing 415 (not illustrated).

The basic information 411 may include a Deal number for identifying a Deal, a name indicating a Deal, one or more lending offices, and customer IDs of one or more borrowers. The Deal summary 412 may include an outline of a transaction. For example, the Deal summary 412 may include information indicating that “the purpose of finance is to provide operating funds for a business company whose head quarter is located in India. The loan period is one year and the amount of financing is 10 million dollars. The lending offices in New Delhi (NDL) and Singapore (SNG) each finance 5 million dollars.

The Deal background 413 may include background circumstance and reason for financing. The lending structure 414 may include an explanatory diagram of a scheme of financing, and an explanation text. The support sharing 415 may indicate the support ratio of respective financial institutions (for example, 40% for Bank A, 35% for Bank B, and 25% for Bank C) in a case where a plurality of financial institutions are involved in financing.

The credit detail information 42 may include detailed information of finance such as detail number, borrower, type of credit, currency, amount of financing, or the like. The collateral detail information 43 may include detailed information of the collateral of the Deal. When a plurality of lending offices are involved in a Deal, the credit detail information 42 may indicate a summed maximum amount resulted from adding maximum amounts which have been set in respective lending offices. The credit detail information 42 and the collateral detail information 43 may include information of a plurality of borrowers.

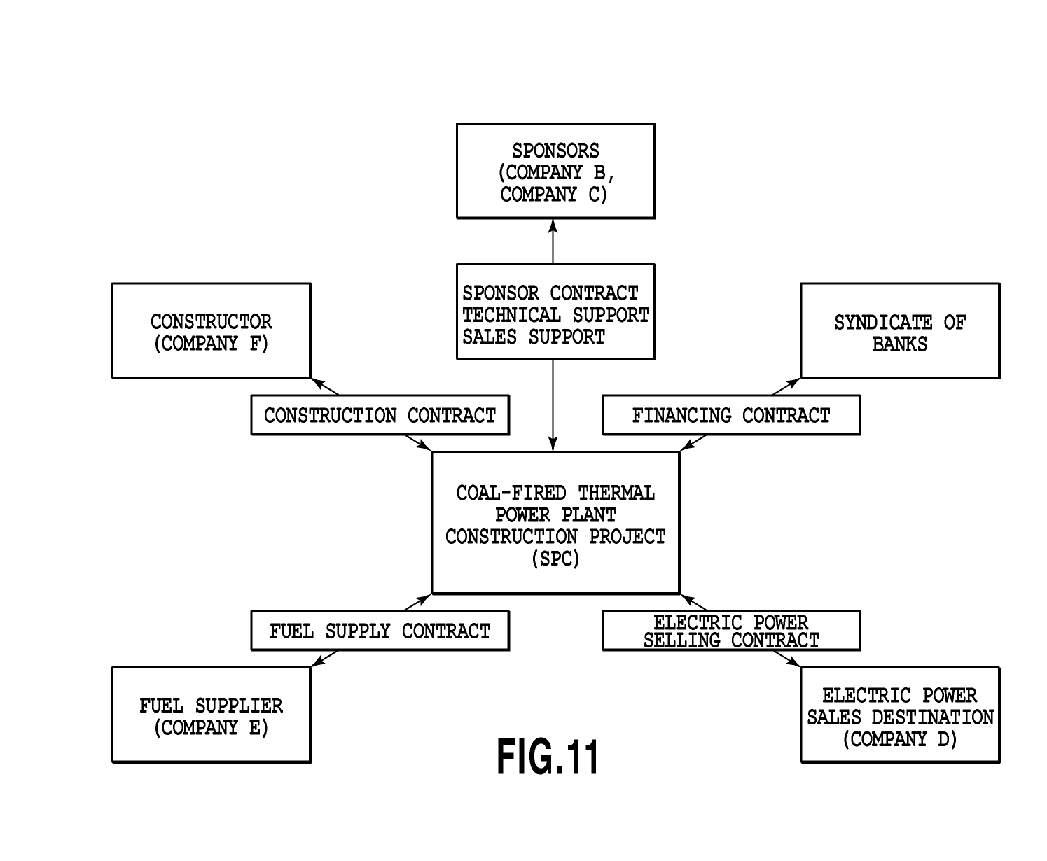

The SL information 44 stores information specific to SL (Specialized Lending) in a case where the type of financing is a structured finance (for example, financing a special purpose company (SPC) for a certain project). An example of a structured finance is illustrated in FIG. 11. In FIG. 11, an SPC that performs a project for constructing a thermal power plant is established by parties involved in the project. A syndicate of banks finance the SPC. Companies B and C, the sponsors, provide technical support and sales support. Company D, the sale destination of electric power, concludes an electric power selling contract and purchases electric power from the thermal power plant. Company E, the fuel supplier, supplies fuel to the thermal power plant. Company F, the constructor of the power plant, constructs the thermal power plant. As illustrated in FIG. 11, structured finance, which is a finance based on a particular business asset and cash flow created by the business, may have a plurality of related parties therein.

The SL information 44 may include an SL number 421, an asset profile 422 (project summary, structure, milestone, etc.), a contract document number 423, financial information 424, and one or more related parties 425 (not illustrated).

The SL number 421 is a number for identifying a structured finance. The asset profile 422 may include information such as summary, scheme (structure), and schedule and milestone of a project. The contract document number 423 indicates identification information of a contract document associated with a structured finance. The financial information 424 indicates financial information (profit and loss statement, balance sheet, cash flow statement, etc.) of a project.

The related parties 425 may include one or more stakeholders of a project, and the stakeholder is indicated by a customer ID of the customer information 31. The related parties 425 may include a role of the stakeholder in the project. For example, a role may include borrower, guarantor, sponsor, underlying asset owner, buyer, seller, and the like. In a structured finance which may have a plurality of parties involved therein, a lending office administrating an SPC, for example, may maintain the SL information 44. Using the related parties 425 allows one or more related parties in the project to be identified. Accordingly, in a case where any damage has occurred in the project, it becomes possible to identify customers who may be affected.

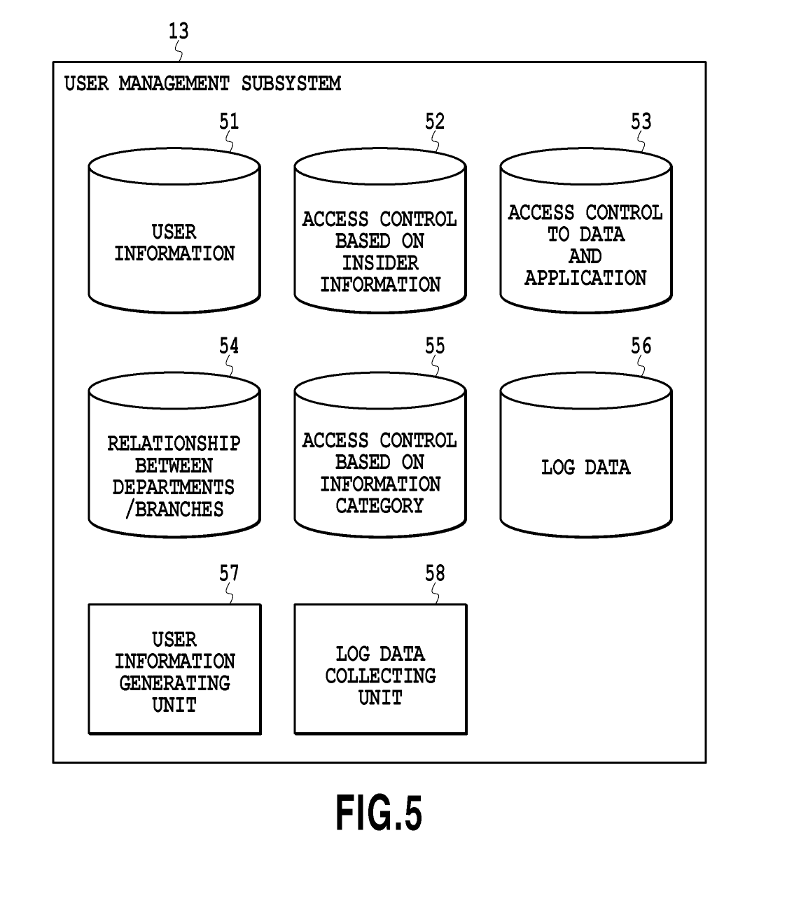

FIG. 5 is a functional block diagram of the user management subsystem 13. The user management subsystem 13 may include, as databases or files, user information 51, access control based on insider information 52, access control to data and application 53, relationship between departments/branches 54, access control based on information category 55, and log data 56. The user management subsystem 13 may include, as processing components, a user information generating unit 57 and a log data collecting unit 58.

The user information 51 may include user information and access control information available in the bank system 10. The user information 51 may include a user ID 521, an organization which user belongs to 522, a credit job position 523, a role 524, and a system operation authority 525 (not illustrated).

The user ID 521 is an ID for identifying a user who uses the bank system 10 and the subsystems 11 to 15. The organization which user belongs to 522 indicates a department of a user (for example, credit department of the head office, sales department of the Singapore branch, etc.). The credit job position 523, which is a job position for credit decision, indicates a job position, such as group manager, or head of branch. These job positions are determined on the basis of official personnel information. The role 524 indicates a role to be accomplished in credit ancillary processes (for example, front, front-middle, middle-back, back, credit department, etc.).

The system operation authority 525 may define a business application operable on the basis of information, such as department or credit job position of a user in order to prevent unnecessary operation by the user. For example, in a case where a credit application for financing to be performed in a Southeast Asian country has been erroneously circulated to a credit department in London, since the personnel belonging to the credit department in London need not refer to the credit application, they cannot access data of requests for managerial decision other than those for predetermined regions.

The access control based on insider information 52 may store setting information for granting only designated users to access secret information, such as a corporate card (elements 31 to 36) of a company planning merger and acquisition (M&A).

The access control to data and application 53 may include access permission information of a user for each piece of information, such as the information 31 to 36 in the customer information management subsystem 11, the Deal Profile 41, the SL information 44 with regard to complicated transactions having a plurality of borrowers involved therein.

The relationship between departments/branches 54 may include information of departments, lending offices, and subsidiaries which need to share customer information of other departments, lending offices and subsidiaries. For example, the Planning dept. Americas division needs to refer to customer information associated with entities under administration thereof (for example, branches in the Unites States). Accordingly, the relationship between departments/branches 54 may include information of referring entities and entities being referred to.

The access control based on information category 55 may indicate a range of disclosure in accordance with the type of information because the range that can be disclosed is different depending on the type of information. For example, since the range of information disclosure is different depending on agreement/disagreement of customers to information disclosure, countries in which entities managing the information are located, and the like, the access control based on information category 55 may include information relating to agreement of customers, and countries in which entries are located.

The user information generating unit 57 is capable of extracting personnel information (organization which user belongs to, job position, role, etc.) of respective users from the personnel information system used in the bank system 10, performing matching of extracted personnel information and information stored in a job position table and a modification information table, which are not illustrated, and generating the user information 51. The job position table defines access authority to the system for each job position of each department/branch, and the modification information table defines access authority information resulted from modifying the default authority which has been set on the basis of personnel job positions.

The log data collecting unit 58 is capable of collecting logs of a particular operation among user operations which have been performed in the bank system 10. The particular operation for which logs are supposed to be collected may be preliminarily determined. For example, when update data is stored in the customer information 31 within the customer information management subsystem 11, log data relating to the operation, for example, user ID, operation date and time, operation terminal, type of operation (addition, correction, deletion, etc.), pre-operation data and post-operation data are transmitted by the customer information management subsystem 11 to the user management subsystem 13. The log data collecting unit 58 may store the transmitted log data in the log data 56.

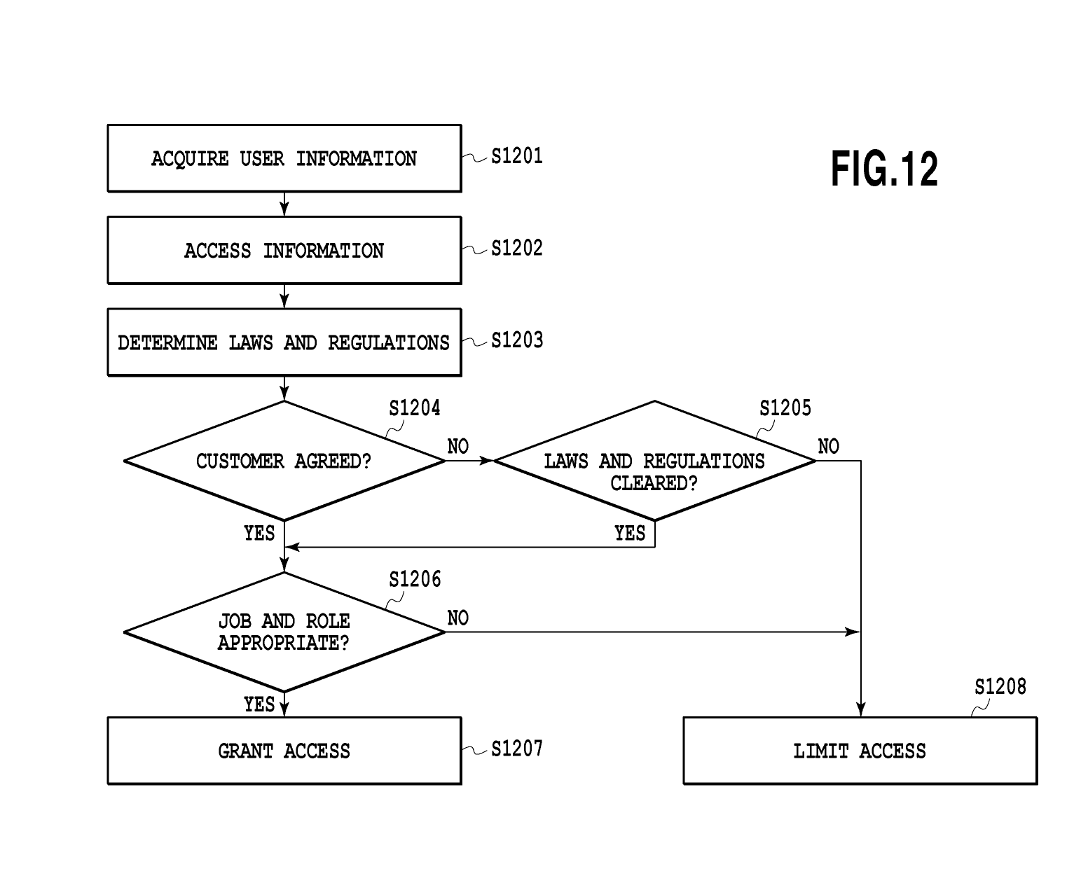

Referring to FIG. 12, an exemplary process flow of the access control performed in the bank system 10 will be described.

At 1201, the user management subsystem 13 acquires the organization which user belongs to 522, the credit job position 523, the role 524, and the system operation authority 525 on the basis of the user ID 521 of the login user.

At 1202, a user attempts to access particular information using the bank terminal 20.

At 1203, the user management subsystem 13 confirms laws and regulations in the country or region where the lending office managing the referred information is located. For example, when the lending office managing the referred information is located in Singapore, the user management subsystem 13 reads the laws and regulations in Singapore among the laws and regulations of respective countries preserved in the subsystem 13. The laws and regulations maybe, for example, the following three patterns.

TABLE 1
laws and regulations of respective countries

| | | range of information sharing | |
|---|---|---|---|
| | | | without |
| pattern of laws and | | with customer's | customer's |
| regulations | | agreement | agreement |
| 1 | information sharable | sharable across | sharable only in |
| | within same corporate | corporate | the corporate |
| | body and same country | bodies/countries | body/country |
| 2 | information sharable | sharable across | sharable only in |
| | within same corporate | corporate | the corporate |
| | body | bodies/countries | body |
| 3 | no information | sharable across | sharable across |
| | sharing regulation | corporate | corporate |
| | | bodies/countries | bodies/countries |

Provided that customer's agreement on information sharing is acquired, it is possible for all of the countries indicated in patterns 1 to 3 to share information across countries/corporate bodies. In a case where customer's agreement on information sharing is not acquired, in a country in pattern 1, it is possible to share information only within the country and corporate bodies therein, and in a country in pattern 2, it is possible to share information only within the corporate bodies therein. Even when customer's agreement on information sharing has not been acquired, in a country in pattern 3, it is possible to share information across the countries/corporate bodies.

At 1204, the user management subsystem 13 performs an inquiry to the customer information management subsystem 11, and determines whether or not a customer agrees to share the referred information. When customer's agreement exists, the process flow proceeds to step 1206. When no customer's agreement exists, the process flow proceeds to step 1205.

At 1205, the user management subsystem 13 determines the pattern of laws and regulations of the country in which the lending office managing the referred information is located. When the determined pattern is pattern 3, the process flow proceeds to step 1206. When the determined pattern is either pattern 1 or pattern 2, the process flow proceeds to step 1208.

At 1206, the user management subsystem 13 determines whether or not the user has an appropriate job position and a role for accessing the information. In the case of having an appropriate job position and a role, the process flow proceeds to step 1207. In the case of not having an appropriate job position and a role, the process flow proceeds to step 1208.

At 1207, the user is allowed to access the information and refer to the information. At 1208, the user has a limited access to the information, or is not allowed to access the information.

Although, in FIG. 12, access control based on information stored in the user information 51 has been described, access control of the present invention may also take the form of another embodiment. In another embodiment, there may be implemented access control that uses one or more of: the user information 51, the insider-information-based access control 52, the data-and-application access control 53, the inter-department/branch relationship 54, and the information-category-based access control 55.

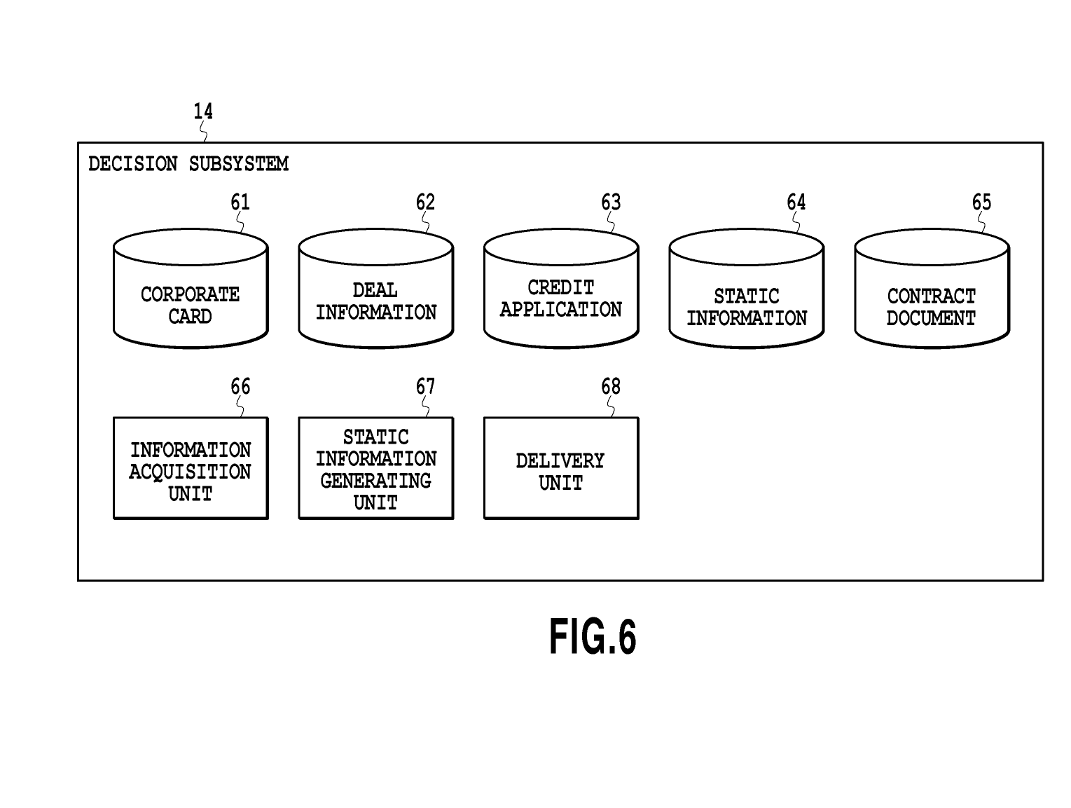

FIG. 6 is a functional block diagram of the decision subsystem 14. The decision subsystem 14 may include, as databases or files, Corporate Card 61, Deal Information 62, credit application 63, Static Information 64, and Contract Document 65. The decision subsystem 14 may include, as processing components, an information acquisition unit 66, a static information generating unit 67, and a delivery unit 68.

The Corporate Card 61 may store a copy of the information of “corporate card” at the time point of drafting a credit application, i.e., the customer information 31, the financial information 32, the financial analysis 33, the credit monitoring 34, the banking relationship 35, and information of the peer comparison 36.

The Deal Information 62 may store a copy of information of: “Deal information” at the time point of drafting a credit application, i.e., the Deal Profile 41, the credit detail information 42, the collateral detail information 43, and the SL information 44. The Deal Information 62 may include status information, the status information indicating “Pending” before a credit application is approved, and “Fixed” after approval.

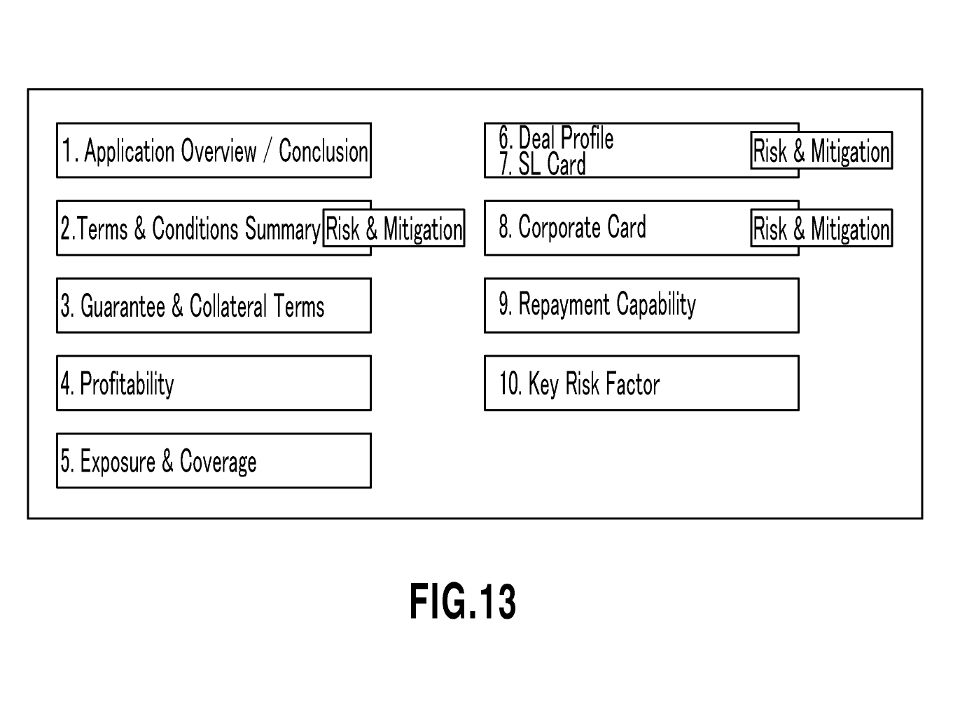

The credit application 63 may store data of a credit application. A credit application may include an ID of the credit application, content illustrated in FIG. 13, and a status. The ID of the credit application indicates an identifier of the credit application, and the status indicates the status of examination (for example, “before approval” or “approved”). A credit application may be associated with the Corporate Card 61 and the Deal Information 62. For example, since a credit application may have an ID of the credit application, an identifier of the Corporate Card 61 associated with the ID of the credit application, and an identifier of the Deal Information 62, the credit application may be associated with the Corporate Card 61 and the Deal Information 62. FIG. 13 illustrates an exemplary format of a credit application. The format may include summary and conclusion of deal, summary of period and terms of financing, guarantee and collateral, profitability, exposure and coverage status, the Deal Profile 41 and the SL information 44, the Corporate Card 61, repayment capability, and a list of major risk factors.

The risk factors indicate risk factors that may affect management of customers (for example, crude oil market, Middle Eastern situation, alliance partners, particular projects, or the like). The bank system 10 is capable of using patterned risk factors registered in a Corporate Card and Deal information to identify Deals that may be affected, and customers associated with the Deals.

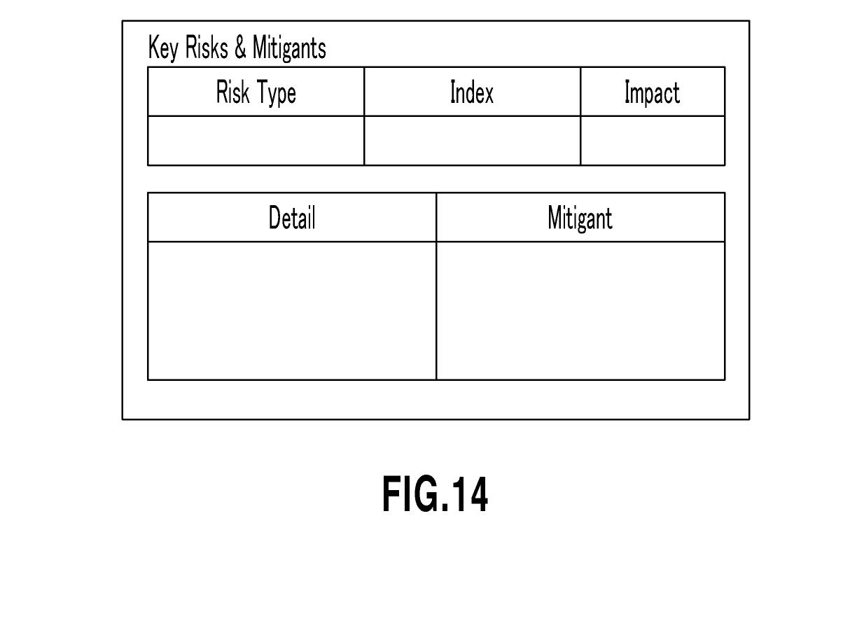

As illustrated in FIG. 13, risk factors may be added to the main part of borrower evaluation/deal evaluation in a credit application. The “10. Key Risk Factor” in the format may display an added risk factor. FIG. 14 illustrates a registration screen of an exemplary risk factor. The registration screen of risk factor may include a risk type (for example, Commodity), an index which may become a risk factor (for example, WTI), a risk degree considering the financial situation of the borrower and a risk mitigation plan (for example, High-Middle-Low), and information relating to a risk content and the mitigation plan for the risk.

The Static Information 64 may store, after approval of a credit application by a head of an entity and before delivery of the credit application to other entities, static information of the credit application at the time of approval. The static information may be PDF data or the like. The Contract Document 65, which is created after the approval of the credit application, may store data of the signed contract document.

The information acquisition unit 66 is capable of acquiring a “corporate card” and “Deal information” at the time point of drafting a credit application from the customer information management subsystem 11 and the deal information management subsystem 12.

The static information generating unit 67 is capable of generating, after approval of a credit application by a head of an entity and before delivery of the credit application other entities, static information of the credit application at the time of approval. More specifically, when an approval button for approving a credit application is pressed down, static information of the credit application is generated. The generated static information is stored in static information 67.

The delivery unit 68 is capable of notifying a confirming person and a person with authority selected by the drafter of a credit application of existence of a credit application to be confirmed. The confirming person and the person with authority who received the notification refer to the content of the credit application stored in the credit application 63, optionally input a comment, and register approval or denial. The drafter may select, on behalf of the confirming person and the person with authority, or in addition to the confirming person and the person with authority, a name of an entity. In a case where a name of a department is selected, the department which has received the credit application may select the confirming person and the approver of the credit application.

In an embodiment of the present invention, the decision subsystem 14 is also capable of acquiring information of corporate card and/or Deal information at the time point when the credit application is approved. Since the information of corporate card and/or the Deal information may be updated with time, the decision subsystem 14 may additionally acquire and hold modification information from the time point of drafting the credit application to the time point of approval.

The decision subsystem 14 is capable of transmitting, after the credit application has been drafted (for example, after a save button has been pressed down), a signal indicating the creation of a credit application to the credit management subsystem 15. The signal is a trigger for generating a control card.

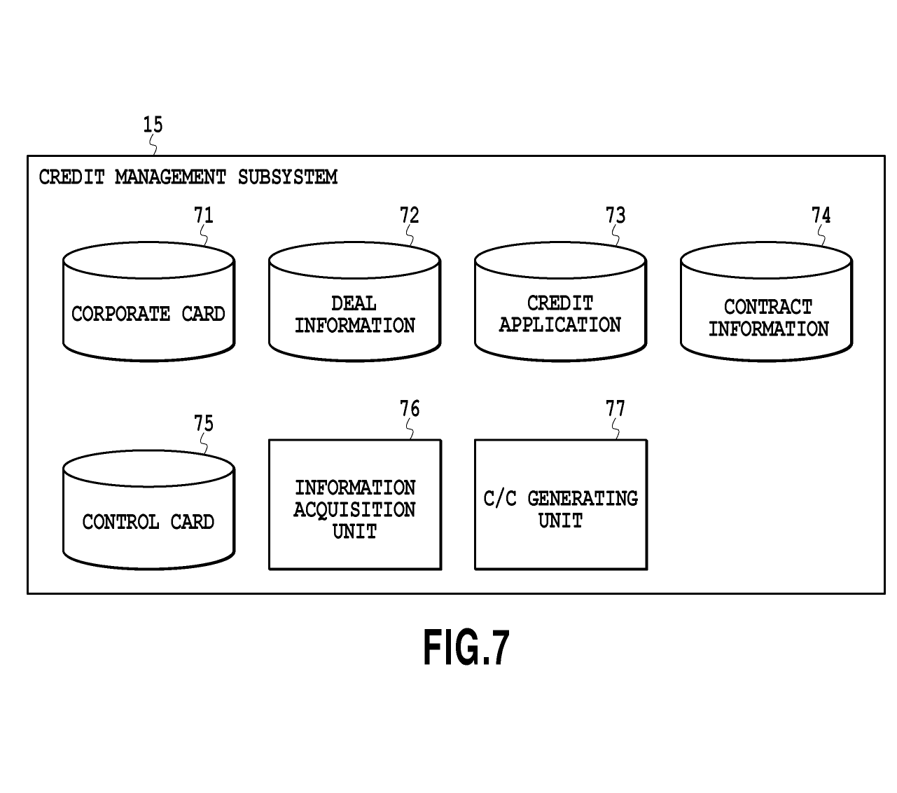

FIG. 7 is a functional block diagram of the credit management subsystem 15. The credit management subsystem 15 may include, as databases or files, Corporate Card 71, Deal Information 72, credit application 73, Contract Information 74, and Control Card 75. The credit management subsystem 15 may include, as processing components, an information acquisition unit 76 and a control card (C/C) generating unit 77.

The credit management subsystem 15 is capable of indicating the progress status of credit business required to be performed. The content of credit business required to be performed and the department (role) in charge of performing credit business may be determined on the basis of Deal information and route information of the credit application. The department that performs credit business may perform credit business according to an assigned role, and input the result to the credit management subsystem 15.

The Corporate Card 71 and the Deal Information 72 include only a part of information included in the Corporate Card 61 and the Deal Information 62. The Contract Information 74 may include the same information as the information included in the Contract Document 65. The credit application 73 may include the same content as the content of the credit application 63.

The information acquisition unit 66 is capable of extracting predetermined information from the Corporate Card 61 and the Deal Information 62, in response to having received the signal indicating the creation of a credit application, and storing the extracted information in the Corporate Card 71 and the Deal Information 72, respectively. The criterion of extracting information is whether or not the information is necessary for credit business. For example, information unnecessary for checking credit business, such as background of financing and company performance, is not stored in the Corporate Card 71 and the Deal Information 72.

The control card generating unit 77 is capable of generating a control card, in response to having received the signal indicating the creation of a credit application from the decision subsystem. 14 and the signal indicating approval of the credit application. The control card generating unit 77 is capable of generating, on the basis of the signal indicating the creation of a credit application, a control card including credit business to be performed prior to approval of the credit application. The control card generating unit 77 is capable of generating, on the basis of the signal indicating approval of a credit application, a control card including credit business to be performed after approval of the credit application. The respective generated control cards may be combined together and used as a single control card. In another embodiment, the control card generating unit 77 is capable of generating, in response to the signal indicating the creation of a credit application, a single control card, and increasing the items to be confirmed in a single control card in accordance with the approval situation of the credit application.

The control card may include the content of credit business required to be performed and a department (role) in charge of performing credit business. The content of credit business required to be performed and the department (role) in charge of performing credit business may be determined on the basis of Deal information and route information of the credit application. For example, with regard to financing for a project performed in U.S.A., and financing for a business company whose headquarter is located in India, credit business required to be performed and departments or branches in charge are different, and therefore different control cards are used. The control card may be referred to as a “C/C” in the present Description.

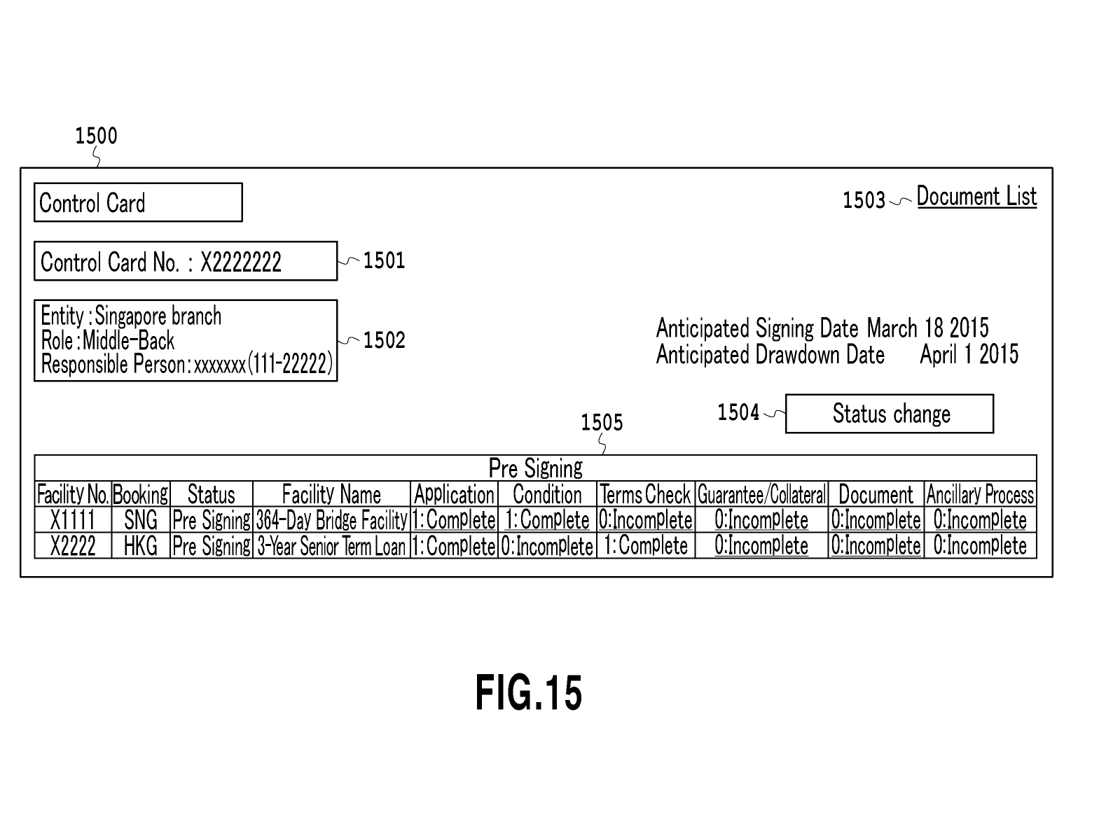

FIG. 15 illustrates an example of a control card 1500. The control card 1500 may include a control card number 1501, an entity in charge and role 1502, a document list 1503, a status change button 1504, and credit business 1505. The control card 1500 may further have an ID of related credit application, an identifier of the Corporate Card 71, and an identifier of the Deal Information 72.

The control card number 1501 is a number for identifying a control card. The entity in charge and role 1502 may indicate an entity (department, branch, etc.) and a role which are responsible for credit business. The entity in charge and role 1502 may further indicate a user ID and a user name.

The document list 1503, when selected by a user, displays a list of contract documents and related documents associated with a control card. When desired data is selected from the list, the credit management subsystem 15 may display the selected data.

The status change button 1504 is used to shift to the next status, when all of the credit businesses required to be performed indicate “Complete”. A status may include “from pre-contract preparations to contract (Pre-Signing)”, “execution preparations (Post-Signing)”, and “execution preparations completed (Available to Drawdown)”.

While the status is “from pre-contract preparations to contract (Pre-Signing) ”, check of contract contents (or check before signing), documents to be collected (various documents) required before signing and ancillary processes, management of credit department conditions, and fulfillment confirmation of collateral and guarantee before signing may be performed.

While the status is “execution preparations (Post-Signing)”, management of collected documents (various Literatures), and fulfillment management of collateral and guarantee after the fact may be performed.

While the status is “execution preparations completed (Available to Drawdown)”, management of collected documents (various papers) in a feasible state of accounting, management of credit department conditions, and fulfillment management of collateral and guarantee after the fact in a feasible state of accounting may be performed.

As illustrated in FIG. 15, the control card 1500 includes credit business for each facility, and may indicate whether or not each of the credit business has been completed. Specifically, the control card 1500 may include two facilities. In FIG. 15, the facility number “X111” indicates that application for financing has been made in Singapore, that it is at the “from pre-contract preparations to contract (Pre-Signing)” stage, and that the name of finance is a “364-day bridge finance”. The control card 1500 may include, as credit business related to each facility, “Application”, “Condition”, “Terms Check”, “Guarantee/Collateral”, “Document”, and “Ancillary Process”.

The credit business “Application” indicates whether or not format check of a credit application and/or approval of a credit application has been completed. The credit business “Condition” indicates whether or not the conditions provided by the credit department at the time of approval of a credit application has been fulfilled. The credit business “Terms Check” indicates whether or not the check of contract contents described in the contract document has been completed. The credit business “Guarantee/Collateral” indicates whether or not guarantee and/or collateral has been fulfilled. The credit business “Document” indicates whether or not the necessary documents to be collected (various documents) has arrived. The credit business “Ancillary Process” indicates whether or not necessary ancillary processes have been completed before signing.

As described above, the credit management subsystem 15 may include a control card for each credit application, and the control card is capable of indicating the progress status of all of the credit businesses required to be performed. The control card 1500 illustrated in FIG. 15 is merely an example, and the control card 1500 may include those other than the credit businesses indicated in the present Description.

Hereinafter, a plurality of cases on credit ancillary processes performed using the bank system 10 and the subsystems 11 to 15 will be described. Such cases explain examples of corporate finance and structured finance. In such cases, as an example of the role 524 stored in the user information 51, “front”, “front-middle”, “middle-back”, “back”, and “credit department” will be described for explanation. As described above, the user information 51 may include the user ID 521, the organization which user belongs to 522, the credit job position 523, the role 524, and the system operation authority 525.

A specific example of the user information 51 is given as follows. For example, the organization and job position associated with a certain person is assistant manager of the sales department of the Singapore branch, and the role of the person is front-middle because the person is engaged in clerical work of sales. For example, the organization and job position associated with another person is senior staff of the clerical department of financing of the Singapore branch, and the role of the person is middle-back because the person is engaged in clerical work of financing. Although the roles and job positions used in the present Description are listed in Table 2, roles and job positions in the Bank 1 are not limited thereto.

TABLE 2
examples of roles, job positions, and job contents

| | example of job | |
|---|---|---|
| role | position | job contents |
| front | sales staff | customer negotiations and creation |
| | | of credit application based thereon |
| front- | sales clerk | format checking of credit |
| middle | | application created by sales staff, |
| | | content confirmation of required |
| | | documents/procedures |
| middle- | staff of clerical | routine checking work such as |
| back | work of financing | confirmation of approved credit |
| | | application and contract document |
| back | staff of | routine operation processing such |
| | accounting | as payments of funds |
| | operation | |
| credit | staff who approves | judge whether or not to perform |
| department | or refuses | financing described in credit |
| | financing | application |

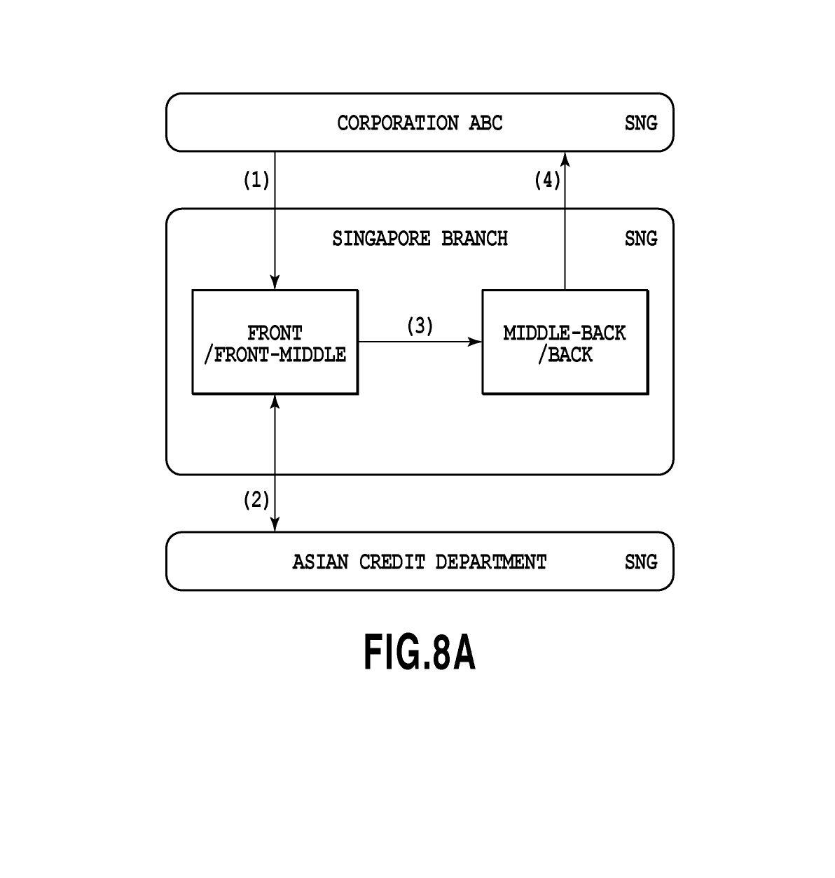

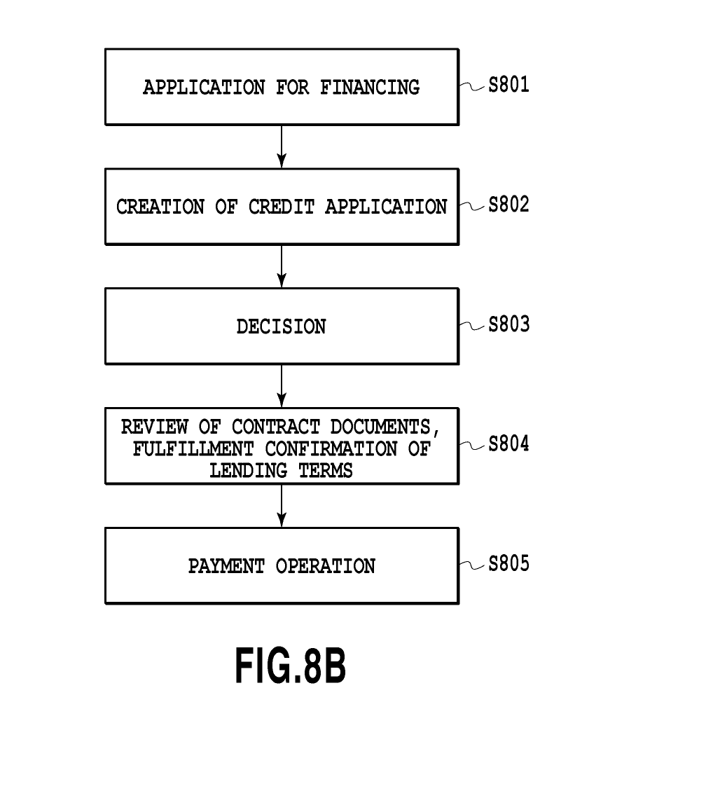

Hereinafter, first and second cases for corporate finance, and a third case for structured finance will be described, referring to FIGS. 8A to 10B.

(First Case)

Referring to FIGS. 8A and 8B, a first case for corporate finance will be described. The first case exemplifies that credit ancillary processes are complete in a single entity (for example, Singapore branch) of the Bank 1. In the present Description and drawings, Singapore may be abbreviated to “SNG”.

FIG. 8A illustrates a flow of credit ancillary process affairs in the first case.

(1) Corporation ABC, a customer in Singapore, applies for financing in a Singapore branch of the Bank 1.

(2) The front of the Singapore branch, in response to having received the application for financing, maintains the corporate card, generates Deal information, and creates a credit application. The front-middle of the Singapore branch checks the format of the credit application and confirms required documents and required procedures. The front-middle of the Singapore branch, after the checking and confirmation, updates the control card. The front-middle of the Singapore branch asks the Asian credit department of the Singapore branch for approval of the credit application. The Asian credit department reviews the credit application, determines lending terms, and approves the financing.

(3) After the approval, the front of the Singapore branch asks the middle-back of the Singapore branch for condition management and operation procedures. The middle-back of the Singapore branch reviews the approved credit application and the contract documents. After the review, the middle-back of the Singapore branch updates the control card.

(4) The middle-back of the Singapore branch, after the review, sets a credit limit to the account of Corporation ABC in the Singapore branch. A credit limit indicates the limit amount of credit (i.e., financing) to be set for a customer. Subsequently, the back of the Singapore branch pays money into the account of Corporation ABC.

Although Table 3 indicates an example of credit businesses for each role described above, credit businesses are not limited to such businesses.

TABLE 3
examples of credit businesses for each role

| | | | | Asian credit |
|---|---|---|---|---|
| front | front-middle | middle-back | back | department |
| creation of | check of | check of | execution | approval of |
| credit | credit | contract | of | financing |
| application | application | documents | withdrawal | |
| creation of | creation and | check of | | |
| contract | signing of | collected | | |
| documents | contract | documents | | |
| | documents | account | | |
| | | frame | | |
| | | registration | | |

FIG. 8B is a flow diagram describing in detail the flow of operations in the first case.

At S801, the front of the Singapore branch of the Bank 1, in response to having received an application for financing from Corporation ABC, may input the latest customer information to the customer information management subsystem via the bank terminal 20. The customer information management subsystem 11 may provide an application for inputting customer information. The input customer information may be stored in the customer information 31, the financial information 32, the financial analysis 33, the credit monitoring 34, the banking relationship 35, and the peer comparison 36, in accordance with contents of the information.

The front of the Singapore branch may input the outline of the financing desired by Corporation ABC to the deal information management subsystem 12. The deal information management subsystem 12 may provide an application for inputting the outline of the financing. The input information may be stored in the Deal Profile 41, the credit detail information 42, and the collateral detail information 43, in accordance with contents of the information. The information stored in the credit detail information 42 and the collateral detail information 43 remains in a pending state until execution of the financing is approved. Since the first case is targeted at corporate finance, the SL information 44 is not used.

At S802, the front of the Singapore branch accesses the decision subsystem. 14 via the bank terminal 20, and creates a credit application. The front of the Singapore branch may optionally set a risk factor in the corporate card and the Deal information. The information acquisition unit 66 of the decision subsystem 14 may acquire the latest data associated with the credit application and stored in the customer information 31, the financial information 32, the financial analysis 33, the credit monitoring 34, the banking relationship 35, and the peer comparison 36 from the customer information management subsystem 11. The acquired data is stored in the Corporate Card 61 in the decision subsystem 14. The information acquisition unit 66 of the decision subsystem 14 may acquire the latest data associated with the credit application and stored in the Deal Profile 41, the credit detail information 42, and the collateral detail information 43 from the deal information management subsystem 12. The acquired data is stored in the Deal Information 62 in the decision subsystem. 14. Through the processes, the decision subsystem 14 may associate the credit application with the information of the customer and the information of the financing deal at the time point of creating the credit application.

When creation of the credit application is completed (for example, after the save button is pressed), the decision subsystem 14 may transmit a signal indicating the creation of the credit application to the credit management subsystem 15. When the signal is received by the credit management subsystem 15, a control card including credit business to be performed before approval of the credit application is generated.

The front of the Singapore branch selects, on the decision subsystem 14, a route (order) of departments and/or persons which examine the created credit application. The decision subsystem 14 may record the selected route in association with the credit application, and transfer the credit application in accordance with the route. The front-middle of the Singapore branch may check the format of the credit application and, upon completing confirmation of the content, may register the completion of confirmation on the decision subsystem 14. After the credit application has been approved, the items “Application” and “Condition” in the control card are automatically updated from “Incomplete” to “Complete”.

At S803, the Asian credit department of the Singapore branch may access the decision subsystem 14 via the bank terminal 20, and approve the credit application which has been circulated thereto. The decision subsystem 14, in response to the approval of the credit application, may transmit a signal indicating the approval to the credit management subsystem. 15. The credit management subsystem 15, in response to having received the signal, may acquire information of the customer from the decision subsystem 14 and store it in the Corporate Card 71, and may also acquire information related to the content of financing from the deal information management subsystem 12 and store it in the Deal Information 72. The credit management subsystem 15, in accordance with the content of the approved credit application (for example, lending terms), may dynamically generate a control card including credit business to be performed after the approval of the credit application and store the generated control card in the Control Card 75. After the approval of the credit application, the front of the Singapore branch creates a contract document in accordance with the content of the credit application. The created contract document, after having been signed, is stored in the Contract Document 65 of the decision subsystem 14. The decision subsystem 14, in response to the storing of the contract document in the Contract Document 65, transmits the content of the contract to the credit management subsystem 15, and the information of the transmitted content of the contract is stored in the Contract Information 74. With regard to the information stored in the Contract Information 74, only the information required for checking in credit business may be referred to by respective roles.

At S804, the middle-back of the Singapore branch reviews the approved credit application and the created contract document, and determines whether or not predetermined check items are fulfilled. The middle-back of the Singapore branch accesses the Control Card 75 of the credit management subsystem 15, and updates the status of check items determined to be fulfilled from “Incomplete” to “Complete”. The middle-back of the Singapore branch, after having reviewed the contract document, may set a credit limit to the account of Corporation ABC in the Singapore branch. It is possible to determine the credit limit on the basis of the lending terms described in the contract document.

At S805, the back of the Singapore branch, in accordance with information, such as the credit limit which has been set and the date and time of payment described in the contract document, performs a payment operation on the bank system 10 via the bank terminal 20. The funds based on the credit limit are paid to the account of Corporation ABC.

(Second Case)

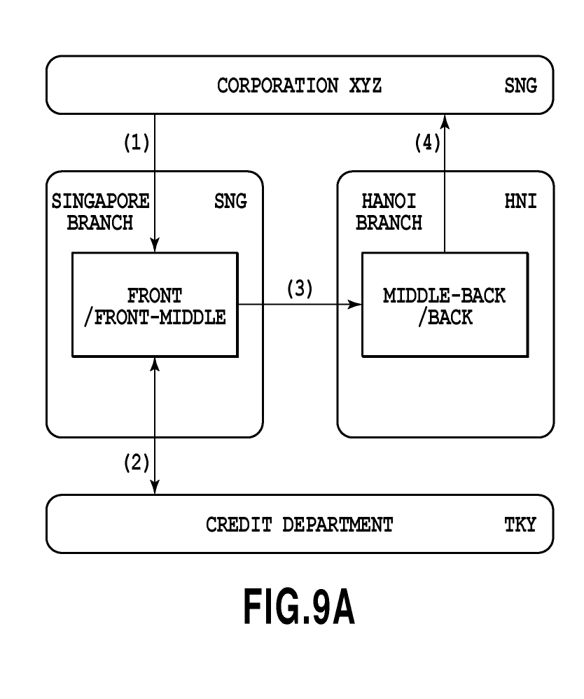

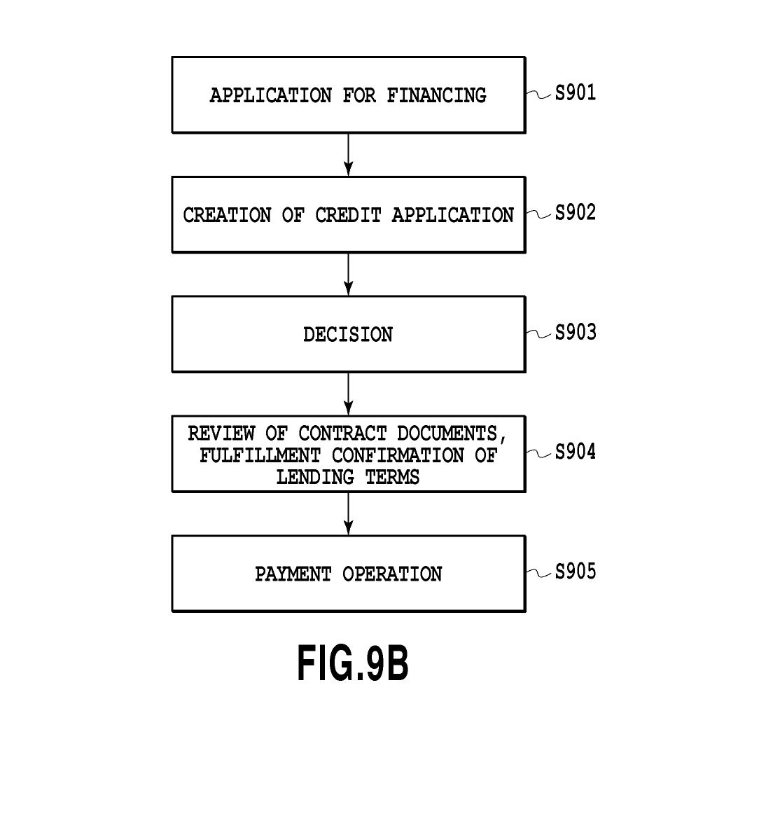

Referring to FIGS. 9A and 9B, a second case for corporate finance will be described. The second case exemplifies that credit ancillary processes are performed by a plurality of entities of the Bank 1 (for example, Singapore branch, Hanoi branch, credit department of head office of Tokyo). In the present Description and the drawings, Hanoi maybe abbreviated as “HNI” and Tokyo may be abbreviated as “TKY.”

FIG. 9A illustrates a flow of credit ancillary processes in the second case.

(1) Corporation XYZ, a customer in Singapore (SNG), applies for financing to a Singapore branch of the Bank 1.

(2) The front of the Singapore branch, in response to having received the application for financing, maintains the corporate card, generates Deal information, and creates a credit application. The front-middle of the Singapore branch checks the format of the credit application and confirms required documents and required procedures. The front-middle of the Singapore branch, after the checking and confirmation, updates the control card. The front-middle of the Singapore branch asks the credit department of the head office for approval of the credit application. The credit department of the head office reviews the credit application, determines lending terms, and approves the financing.

(3) After the approval, the front of the Singapore branch asks the middle-back of the Hanoi branch of Vietnam for condition management and operation procedures. The middle-back of the Hanoi branch reviews the approved credit application and the contract documents. After the review, the middle-back of the Hanoi branch updates the control card.

(4) The middle-back of the Hanoi branch, after the review, sets a credit limit to the account of Corporation XYZ in the Hanoi branch. A credit limit indicates the limit amount of credit (i.e., financing) to be set for a customer. Subsequently, the back of the Hanoi branch pays money into the account of Corporation XYZ.

FIG. 9B is a flow diagram describing in detail the flow of operations in the second case.

At S901, the front of the Singapore branch of the Bank 1, in response to having received an application for financing from Corporation XYZ, may input the latest customer information to the customer information management subsystem via the bank terminal 20. The customer information management subsystem 11 may provide an application for inputting customer information. The input customer information may be stored in the customer information 31, the financial information 32, the financial analysis 33, the credit monitoring 34, the banking relationship 35, and the peer comparison 36, in accordance with contents of the information.

The front of the Singapore branch may input the outline of the financing desired by Corporation XYZ to the deal information management subsystem 12. The deal information management subsystem 12 may provide an application for inputting the outline of the financing. The input information may be stored in the Deal Profile 41, the credit detail information 42, and the collateral detail information 43, in accordance with contents of the information. The information stored in the credit detail information 42 and the collateral detail information 43 remains in a pending state until execution of the financing is approved. Since the second case is targeted at corporate finance, the SL information 44 is not used.

At S902, the front of the Singapore branch accesses the decision subsystem 14 via the bank terminal 20, and creates a credit application. The front of the Singapore branch may optionally set a risk factor in the corporate card and the Deal information. The information acquisition unit 66 of the decision subsystem 14 may acquire the latest data associated with the credit application and stored in the customer information 31, the financial information 32, the financial analysis 33, the credit monitoring 34, the banking relationship 35, and the peer comparison 36 from the customer information management subsystem 11. The acquired data is stored in the Corporate Card 61 in the decision subsystem 14. The information acquisition unit 66 of the decision subsystem 14 may acquire the latest data associated with the credit application and stored in the Deal Profile 41, the credit detail information 42, and the collateral detail information 43 from the deal information management subsystem 12. The acquired data is stored in the Deal Information 62 in the decision subsystem 14. Through the processes, the decision subsystem 14 may associate the credit application with the information of the customer and the information of the financing deal at the time point of creating the credit application.

When creation of the credit application is completed (for example, after the save button is pressed), the decision subsystem 14 may transmit a signal indicating the creation of the credit application to the credit management subsystem 15. When the signal is received by the credit management subsystem 15, a control card including credit business to be performed before approval of the credit application is generated.

The front of the Singapore branch selects, on the decision subsystem 14, a route (order) of departments and/or persons which examine the created credit application. The decision subsystem 14 may record the selected route in association with the credit application, and transfer the credit application in accordance with the route. The front-middle of the Singapore branch may check the format of the credit application and, upon completing confirmation of the content, may register the completion of confirmation on the decision subsystem 14. After the credit application has been approved, the items “Application” and “Condition” in the control card are automatically updated from “Incomplete” to “Complete”.

At S903, the credit department of the head office may access the decision subsystem 14 via the bank terminal 20, and approve the credit application which has been circulated thereto. The decision subsystem 14, in response to the approval of the credit application, may transmit a signal indicating the approval to the credit management subsystem 15. The credit management subsystem 15, in response to having received the signal, may acquire information of the customer from the decision subsystem 14 and store it in the Corporate Card 71, and may acquire information related to the content of financing from the deal information management subsystem 12 and store it in the Deal Information 72. The credit management subsystem 15, in accordance with the content of the approved credit application (for example, lending terms), may dynamically generate a control card including credit business to be performed after the approval of the credit application and store the generated control card in the Control Card 75. After the approval of the credit application, the front of the Singapore branch creates a contract document in accordance with the content of the credit application. The created contract document, after having been signed, is stored in the Contract Document 65 of the decision subsystem 14. The decision subsystem 14, in response to the storing of the contract document in the Contract Document 65, transmits the content of the contract to the credit management subsystem 15, and the information of the transmitted content of the contract is stored in the Contract Information 74. With regard to the information stored in the Contract Information 74, only the information required for checking in credit business may be referred to by respective roles.

At S904, the middle-back of the Hanoi branch reviews the approved credit application and the created contract document, and determines whether or not predetermined check items are fulfilled. The middle-back of the Hanoi branch accesses the Control Card 75 of the credit management subsystem 15, and updates the status of check items determined to be fulfilled from. “Incomplete” to “Complete”. The middle-back of the Hanoi branch, after having reviewed the contract document, may set a credit limit to the account of Corporation XYZ in the Hanoi branch. It is possible to determine the credit limit on the basis of the lending terms described in the contract document.

At S905, the back of the Hanoi branch, in accordance with information, such as the credit limit which has been set and the date and time of payment described in the contract document, performs a payment operation on the bank system 10 via the bank terminal 20. The funds based on the credit limit are paid into the account of Corporation XYZ.

(Third Case)

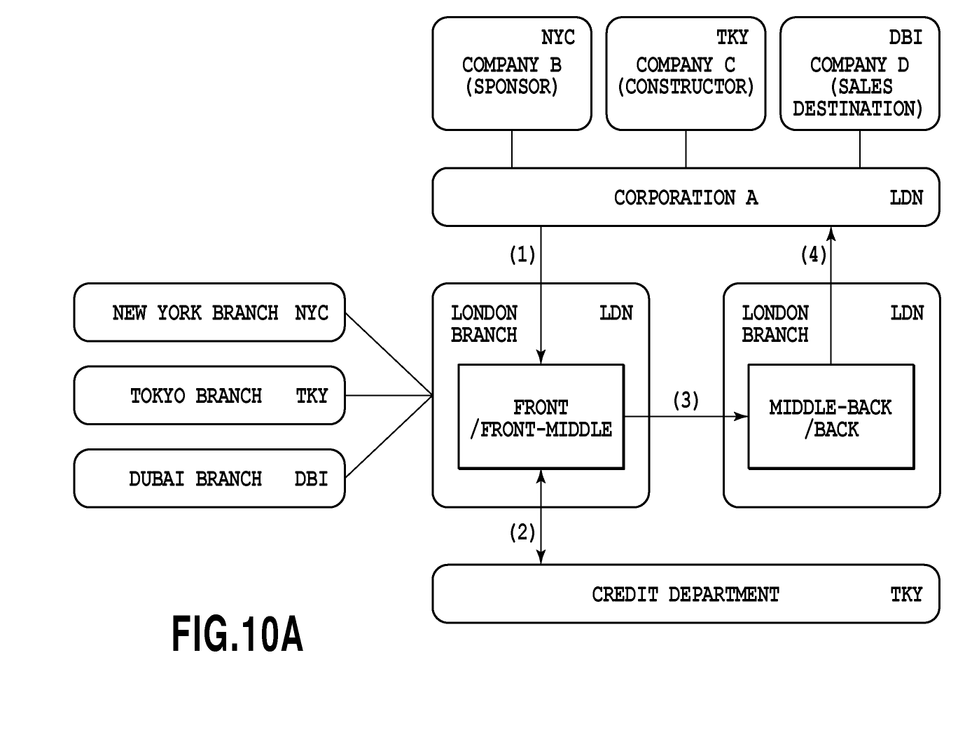

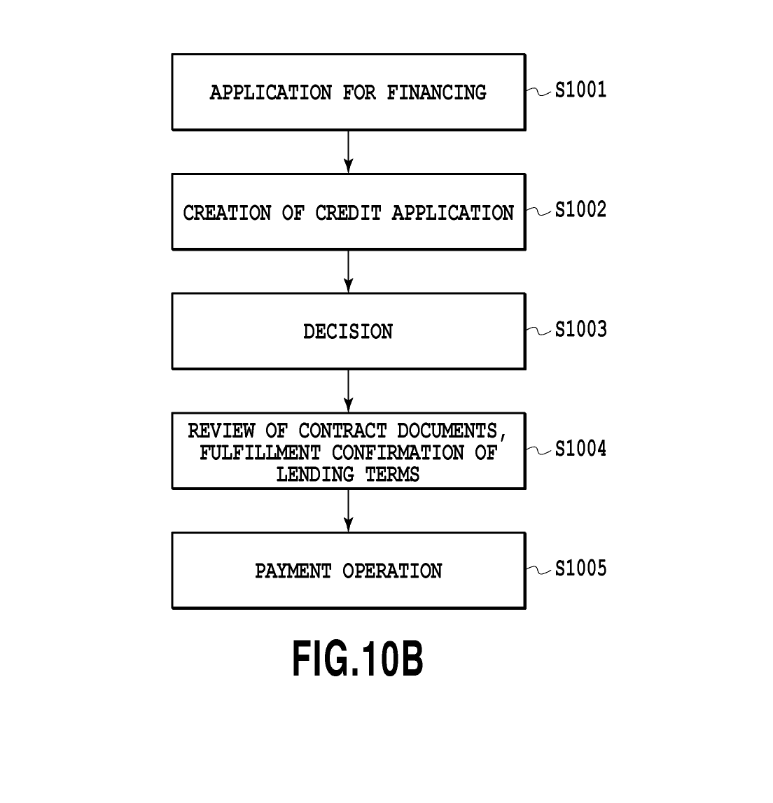

Referring to FIGS. 10A and 10B, a third case for structured finance will be described. The third case exemplifies that credit ancillary processes are performed by a plurality of entities of the Bank 1 (for example, London branch, New York branch, Tokyo branch, Dubai branch, credit department of head office of Tokyo). In the present Description and drawings, London may be abbreviated as “LDN”, New York may be abbreviated as “NYC”, and Dubai may be abbreviated as “DBI.”

FIG. 10A illustrates a flow of credit ancillary processes in the third case. The third case describes financing for a natural gas refining facility construction project as an example. Company B, the sponsor of the project, is a customer of the New York branch, Company C, the constructor, is a customer of the Tokyo branch, and Company D, the sale destination, is a customer of the Dubai branch. Corporation A, an SPC established for the project by Company B, Company C, and Company D, is a customer of the London branch. In the project, Corporation A is the borrower.

(1) Corporation A in London (LDN) applies for financing to the London branch of the Bank 1. The front of the London branch updates the corporate card of Corporation A, and generates Deal information. The fact that there has been an application for financing is notified to the New York branch, the Tokyo branch, and the Dubai branch respectively in charge of Company B, Company C, and Company D, which are related parties in the project. Respective fronts of the New York branch, the Tokyo branch, and the Dubai branch update the Corporate Cards of Company B, Company C, and Company D.

(2) The front of the London branch creates a credit application in response to having received the application for financing. The front-middle of the London branch checks the format of the credit application and confirms required documents and required procedures. The front-middle of the London branch, after the checking and confirmation, updates the control card. The front-middle of the London branch asks credit department of the head office of Tokyo for approval of the credit application. The credit department of the head office reviews the credit application, determines lending terms, and approves the financing.

(3) After the approval, the front of the London branch asks the middle-back of the London branch for condition management and operation procedures. The middle-back of the London branch reviews the approved credit application and the contract documents. After the review, the middle-back of the London branch updates the control card.

(4) The middle-back of the London branch, after the review, sets a credit limit to the account of Corporation A in the London branch. A credit limit indicates the limit amount of credit (i.e., financing) to be set for the customer. Subsequently, the back of the London branch pays money into the account of Corporation A.

FIG. 10B is a flow diagram describing in detail the flow of operations in the third case.

At S1001, the front of the London branch of the Bank 1, in response to having received an application for financing from Corporation A, may input the latest customer information to the customer information management subsystem 11 via the bank terminal 20. The customer information management subsystem 11 may provide an application for inputting customer information. The input customer information of Corporation A may be stored the customer information 31, the financial information 32, the financial analysis 33, the credit monitoring 34, the banking relationship 35, and the peer comparison 36, in accordance with contents of the information.

The front of the London branch may input the outline of the financing desired by Corporation A to the deal information management subsystem 12. The deal information management subsystem 12 may provide an application for inputting the outline of the financing. The input information may be stored in the Deal Profile 41, the credit detail information 42, the collateral detail information 43, and the SL information 44, in accordance with contents of the information. The information stored in the credit detail information 42 and the collateral detail information 43 remains in a pending state until execution of the financing is approved. Since the third case is targeted at structured finance, the SL information 44 is used. The SL information 44 has stored therein identifiers of Company B, Company C, and Company D, which are stakeholders of the project.

The deal information management subsystem 12 may notify the fact that there has been an application for financing to the New York branch, the Tokyo branch, and the Dubai branch respectively in charge of Company B, Company C, and Company D, which are related parties in the project. In response to the notification, respective fronts of the New York branch, the Tokyo branch, and the Dubai branch may access the customer information management subsystem 11 via the bank terminal 20, and input the latest customer information of Company B, Company C, and Company D, respectively. The input customer information of Company B, Company C, and Company D may be stored in the customer information 31, the financial information 32, the financial analysis 33, the credit monitoring 34, the banking relationship 35, and the peer comparison 36, in accordance with contents of the information.

At S1002, the front of the London branch accesses the decision subsystem. 14 via the bank terminal 20, and creates a credit application. The front of the London branch may optionally set a risk factor in the corporate card and the Deal information. The information acquisition unit 66 of the decision subsystem 14 may acquire the latest data associated with the credit application and stored in the customer information 31, the financial information 32, the financial analysis 33, the credit monitoring 34, the banking relationship 35, and the peer comparison 36 from the customer information management subsystem 11. The acquired data is stored in the Corporate Card 61 in the decision subsystem 14. The information acquisition unit 66 of the decision subsystem 14 may acquire the latest data associated with the credit application and stored in the Deal Profile 41, the credit detail information 42, the collateral detail information 43, and the SL information 44 from the deal information management subsystem 12. The acquired data is stored in the Deal Information 62 in the decision subsystem 14. Through the processes, the decision subsystem 14 may associate the credit application with the information of the customer and the information of financing Deal at the time point of creating the credit application.

When creation of the credit application is completed (for example, after the save button is pressed), the decision subsystem 14 may transmit a signal indicating the creation of the credit application to the credit management subsystem 15. When the signal is received by the credit management subsystem 15, a control card including credit business to be performed before approval of the credit application is generated.

The front of the London branch selects, on the decision subsystem 14, a route (order) of departments and/or persons which examine the created credit application. The decision subsystem 14 may record the selected route in association with the credit application, and transfer the credit application in accordance with the route. The front-middle of the London branch may check the format of the credit application and, upon completing confirmation of the content, may register the completion of confirmation on the decision subsystem 14. After the credit application has been approved, the items “Application” and “Condition” in the control card are automatically updated from “Incomplete” to “Complete”.

At S1003, the credit department of the head office may access the decision subsystem 14 via the bank terminal 20, and approve the credit application which has been circulated thereto. The decision subsystem 14, in response to the approval of the credit application, may transmit a signal indicating the approval to the credit management subsystem 15. The credit management subsystem 15, in response to having received the signal, may acquire information of the customer from the decision subsystem 14 and store it in the Corporate Card 71, and may acquire information related to the content of financing from the deal information management subsystem 12 and store it in the Deal Information 72. The credit management subsystem 15, in accordance with the content of the approved credit application (for example, lending terms), may dynamically generate a control card including credit business to be performed after the approval of the credit application and store the generated control card in the Control Card 75. After the approval of the credit application, the front of the London branch creates a contract document in accordance with the content of the credit application. The created contract document, after having been signed, is stored in the Contract Document 65 of the decision subsystem 14. The decision subsystem 14, in response to the storing of the contract document in the Contract Document 65, transmits the content of the contract to the credit management subsystem 15, and the information of the transmitted content of the contract is stored in the Contract Information 74. With regard to the information stored in the Contract Information 74, only the information required for checking in credit business may be referred to by respective roles.

At S1004, the middle-back of the London branch reviews the approved credit application and the created contract document, and determines whether or not predetermined check items are fulfilled. The middle-back of the London branch accesses the Control Card 75 of the credit management subsystem 15, and updates the status of check items determined to be fulfilled from “Incomplete” to “Complete”. The middle-back of the London branch, after having reviewed the contract document, may set a credit limit to the account of Corporation A in the London branch. It is possible to determine the credit limit on the basis of the lending term described in the contract document.

At S1005, the back of the London branch, in accordance with information, such as the credit limit which has been set and the date and time of payment described in the contract document, performs a payment operation on the bank system 10 via the bank terminal 20. The funds based on the credit limit are paid into the account of Corporation A.

According to the present invention, the bank system 10 is capable of extracting financing deals associated with a company exhibiting a poor performance by searching Deal information or SL information on the basis of the customer ID of the company. According to the present invention, when a certain project has resulted in an enormous loss, the bank system 10 is capable of identifying related parties on the basis of the SL information, and extracting financing deals for each of the identified related parties. According to the present invention, the bank system 10 is capable of providing progress status of credit ancillary processes and therefore may perform a more effective credit management.

Although the principle of the present invention has been described above, referring to exemplary embodiments, a person skilled in the art will understand that there may be realized various embodiments with varying configuration and details without deviating from the spirit of the present invention. Although the present Description has described embodiments in which the bank system 10 includes the subsystems to 15, the present invention may be applied to other embodiments. For example, as long as the bank system 10 has the functions and the databases/files of the subsystems 11 to 15, the subsystems 11 to 15 need not be used.

The present invention may take the form of embodiments such as, for example, a system, a device, a method, a program, or a storage medium.

1. A bank system for corporate finance overseas credit management, comprising:
first storage unit that stores customer information, the customer information being sharable by a plurality of entities, the plurality of entities including a plurality of branches and/or a plurality of local corporations;
second storage unit that stores information relating to a credit transaction management unit, the information relating to a credit transaction management unit having information of one or more lending offices and information of one or more borrowers, the borrowers being associated with the customer information; and
a processor; wherein the processor being configured to perform the following processing:
approving execution of a credit transaction described in a credit application with the customer information and the information relating to a credit transaction management unit at the time of creation of the credit application, and generating a first signal at the time of approval of the credit application; and
generating a control card in response to the first signal, the control card indicating progress status of ancillary processes of the approved credit transaction, wherein
the customer information and the information relating to a credit transaction management unit are maintained by a first entity.

2. The bank system according to claim 1, wherein the processor being further configured to perform the following processing:
generating a second signal at the time of creating the credit application, and
generating a second control card in response to the second signal, and the second control card is capable of being coupled to the control card.

3. The bank system according to claim 1, wherein
the control card is updated by a second entity, and
the first entity has a first role and the second entity has a second role.

4. The bank system according to claim 3, wherein the first role is front, and the second role is middle-back.

5. The bank system according to claim 1, wherein
the control card is updated by the first entity, and
the first entity has a first role and a second role.

6. The bank system according to claim 5, wherein the first role is front, and the second role is middle-back.

7. The bank system according to claim 1, wherein the first entity is a Primary Lending Office (PLO).

8. The bank system according to claim 1, wherein the processor being further configured to
perform access control to the customer information, the information relating to a credit transaction management unit, and the control card, wherein
the access control is performed at least on a basis of an entity of a user, credit job position, and role.

9. The bank system according to claim 1, wherein
the credit application includes one or more risk factors, and
wherein the processor being further configured to extract a credit transaction associated with the risk factor.

10. A method performed by a bank system for corporate finance overseas credit management, the method comprising:
updating customer information, the customer information being sharable by a plurality of entities, the plurality of entities including a plurality of branches and/or a plurality of local corporations;
updating information relating to a credit transaction management unit, the information relating to a credit transaction management unit having information of one or more lending offices and information of one or more borrowers, and the borrowers being associated with the customer information;
acquiring, in response to creation of a credit application, the customer information and the information relating to a credit transaction management unit;
generating a first signal in response to approval of a credit transaction described in the credit application; and
generating a control card in response to the first signal, the control card indicating progress status of ancillary processes of the approved credit transaction, wherein
the customer information and the information relating to a credit transaction management unit are maintained by a first entity.

11. The method according to claim 10, further comprising:
generating a second signal in response to creation of the credit application; and
generating a second control card in response to the second signal, the second control card being capable of being coupled to the control card.

12. The method according to claim 10, wherein
the control card is updated by a second entity, and
the first entity has a first role, and the second entity has a second role.

13. The method according to claim 10, wherein
the control card is updated by a first entity, and
the first entity has a first role and a second role.

14. The method according to claim 10, further comprising
performing access control to the customer information, the information relating to a credit transaction management unit, and the control card, the access control being performed at least on a basis of an entity of a user, credit job position, and role.

15. A non-transitory computer-readable storage medium having computer-executable instructions which causes a bank system for corporate finance overseas credit management to perform a method comprising:
updating customer information, the customer information being sharable by a plurality of entities, the plurality of entities including a plurality of branches and/or a plurality of local corporations;
updating information relating to a credit transaction management unit, the information relating to a credit transaction management unit having information of one or more lending offices and information of one or more borrowers, and the borrowers being associated with the customer information;
acquiring, in response to creation of a credit application, the customer information and the information relating to a credit transaction management unit;
generating a first signal in response to approval of a credit transaction described in the credit application; and
generating a control card in response to the first signal, the control card indicating progress status of ancillary processes of the approved credit transaction, wherein
the customer information and the information relating to a credit transaction management unit are maintained by a first entity.
